(19) United States
(12) Patent Application Publication
(10) Pub. No.: US 2026/0269202 A1
(43) Pub. Date: Sep. 10, 2026

(54) Multidimensional Variable Scanning SWATH Mass Spectrometry

(71) Applicant: DH Technologies Development Pte. Ltd., Singapore (SG)

(72) Inventors: Stephen TATE, Barrie (CA); Nicholas G. BLOOMFIELD, Newmarket (CA)

(21) Appl. No.: 19/166,627

(22) PCT Filed: Mar. 19, 2024
(86) PCT No.: PCT/IB2024/052653

§ 371 Date: Sep. 18, 2025

Related U.S. Application Data
(60) Provisional application No. 63/453,822, filed on Mar. 22, 2023.

(51) Int. Cl. H01J 49/00; H01J 49/42

(52) U.S. Cl. CPC H01J 49/0031; H01J 49/0045; H01J 49/4215

(57) ABSTRACT

In one aspect, a method of acquiring mass data in a mass spectrometric system is disclosed, which includes introducing a plurality of ions into a mass filter providing a mass selection window to allow passage of precursor ions having m/z ratios within the mass selection window through the mass filter and scanning the mass selection window and adjusting a width thereof across a mass range during acquisition of mass data.

### RELATED APPLICATIONS

This application claims priority to U.S. Provisional Application No. 63/453,822 filed on Mar. 22, 2023, the contents of which are incorporated herein in their entirety.

### TECHNICAL FIELD

The present disclosure relates to mass spectrometry and more particularly to methods and systems for use in acquiring MRM mass spectra of compounds in SWATH data acquisition mode.

### BACKGROUND

Mass spectrometry (MS) is an analytical technique for determining the structure of test chemical substances with both qualitative and quantitative applications. MS can be useful for identifying unknown compounds, determining the composition of atomic elements in a molecule, determining the structure of a compound by observing its fragmentation and quantifying the amount of a particular chemical compound in a mixed sample. Mass spectrometers detect chemical entities as ions such that a conversion of the analytes to charged ions must occur during the sampling process.

Mass spectrometry/mass spectrometry (MS/MS), also known as tandem mass spectrometry, is a method that can provide both qualitative and quantitative mass information. In MS/MS, a first mass analyzer (herein also referred to as a mass filter) is employed to select a precursor ion, which is fragmented to generate product ions. The product ions are analyzed by a second mass analyzer.

The sensitivity and specificity of a tandem mass spectrometer is affected by the width of the precursor mass selection window (herein also referred to as “mass transmission window” or “ion transmission window”) established by the first mass analyzer. Wide precursor mass windows transmit more ions giving increased sensitivity. However, wide precursor mass windows may also allow precursor ions of different masses to pass. If the precursor ions of other masses produce product ions at the same mass as the selected precursor ion, ion interference can occur, which results in decreased specificity.

Conventionally, the most common MS/MS technique has been Data Dependent Acquisition (DDA) in which a precursor ion is isolated, fragmented to generate product ions, and the product ions are analyzed. The DDA technique can provide high quality mass data, for stochastically selected precursor ions. Another MS/MS technique known as SWATH-MS (sequential window acquisition of all theoretical mass spectra), or simply SWATH, is a type of data-independent acquisition (DIA) technique, in which all precursor ions within a mass selection window are fragmented and the mass spectra of product ions associated with all of the precursor ions passing through the mass selection window are collected and the mass selection window is stepped through an entire mass range of interest using stepped windows of the same or variable widths.

SWATH data acquisition technique can lead to a higher sensitivity. But it may be difficult to correlate the product ions to specific precursors ions. In particular, each mass selection window can contain multiple precursor ions, which can confound the identification of the correct precursor ion for a set of product ions.

### SUMMARY

In one aspect, a method of acquiring mass data in a mass spectrometric system is disclosed, which includes introducing a plurality of ions into a mass filter providing a mass selection window to allow passage of precursor ions having m/z ratios within the mass selection window through the mass filter and scanning the mass selection window and adjusting a width thereof across a mass range during acquisition of mass data.

The scanning of the mass selection window can include varying at least a first operating parameter of the mass filter. Further, the adjustment of the width of the mass selection window can include varying at least a second operating parameter of the mass filter.

In some embodiments, the mass filter can include a plurality of rods that are arranged in a multipole configuration. In some such embodiments, the first operating parameter can include a radio frequency (RF) voltage applied to at least one of the rods of the multipole set of rods. Further, in some such embodiments, the second operating parameter can include a DC (direct current) resolving voltage applied to at least one of the rods of the multipole set of rods.

In some embodiments, the method can further include causing fragmentation of the precursor ions passing through the mass selection window to generate a plurality of ion fragments. The method can also include acquiring mass data associated with the ion fragments. The acquired mass data can be analyzed to generate a mass spectrum of the ion fragments.

In some embodiments, the adjustment of the width of the mass selection window can be based on mass reference data indicative of expected mass peaks within an m/z range for which mass data is to be acquired. By way of example, the mass reference data can be generated by performing a mass survey scan.

In some embodiments, the adjustment of the width of the mass selection window can include reducing or increasing the width of the window for an m/z range so that there are approximately 10 peaks per window. Substantially more than 10 peaks per window can be characterized as being a dense distribution of mass peaks and substantially less than 10 peaks per window can be characterized as being a sparse distribution of mass peaks. For example, an m/z window range exhibiting more than 10 mass peaks can be characterized as exhibiting a dense mass peak distribution and the width of the mass selection window can be reduced so that approximately 10 mass peaks are present and an m/z window range exhibiting a mass peak distribution of less than 10 peaks may be characterized as exhibiting a sparse mass peak distribution and the width of the mass selection window can be increased so that approximately 10 mass peaks are present

Further, in some embodiments, the rate of scanning of the mass selection window can be adjusted based on the mass reference data. In some such embodiments, the adjustment of the scanning rate can include reducing the scanning rate for an m/z range characterized by at least one mass peak for which an increased dwell time is desired. In some embodiments, the adjustment of the scanning rate can include increasing the scanning rate for acquisition of mass data in an m/z range characterized by one or more mass peaks having an expected intensity less than a predefined threshold. Further, in some embodiments, the adjustment of the scanning rate can include decreasing the scanning rate for acquisition of mass data in an m/z range in which mass peaks have an expected intensity greater than a predefined threshold.

In a related aspect, a method of acquiring mass data in a mass spectrometer system is disclosed, which comprises introducing a plurality of ions into a mass filter of the mass spectrometer system, filtering the ions introduced into the mass filter using a mass transmission window of the mass filter, scanning the mass transmission window of the mass filter over a mass range of interest, and adjusting a width of the mass transmission window of the mass filter over at least a portion of the mass range of interest during the scanning of the mass transmission window.

In some embodiments, the step of adjusting the width of the mass transmission window can be performed based on a density of the m/z peaks associated with the ions passing through the mass filter.

In a related aspect, a mass analysis system is disclosed, which includes a mass filter for receiving a plurality of precursor ions, and a controller for causing scanning of a mass selection window provided by the mass filter and adjusting a width of the mass selection window during acquisition of mass data. The mass analysis system can also include a fragmentation device positioned downstream of the mass filter for receiving and fragmenting at least a portion of the precursor ions to generate a plurality of ion fragments.

The controller can be configured to utilize mass reference data for adjusting the width of the mass selection window. By way of example, the mass reference data may correspond to data acquired via a mass survey scan. The controller can also be configured to adjust a rate of scanning of the mass selection window based on the mass reference data. By way of example, the controller can be configured to increase the width of the mass selection window for m/z regions having a sparse distribution of mass peaks and to decrease the width of the mass selection window for m/z regions having a dense distribution of mass peaks. By way of further example, the controller can be configured to increase the scanning rate of the mass selection window over m/z ranges in which the mass peaks are expected to have a high intensity, e.g., an intensity greater than a threshold, and to reduce the scanning rate of the mass selection window over m/z ranges in which the mass peaks are expected to have a low intensity, e.g., an intensity less than a threshold.

In some embodiments, the mass filter can include a plurality of rods that are arranged in a multipole configuration, e.g., a quadrupole configuration. In such embodiments, the mass analysis system can further include at least one RF voltage source and at least one DC voltage source for applying RF and/or DC voltages to one or more of the rods. In such embodiments, the controller can be configured to adjust the RF voltage, e.g., by varying the RF voltage continuously between a lower and an upper voltage, to cause scanning of the mass selection window and to adjust the RF and DC voltages to adjust the m/z width of the mass selection window. In some embodiments, the controller can receive mass reference data and can adjust the scanning rate of the mass selection window and/or the width of the mass selection window based on the reference data.

In a related aspect, a method of acquiring mass data in a mass spectrometer system is disclosed, which comprises introducing a plurality of ions into a mass filter of the mass spectrometer system, filtering the ions introduced into the mass filter using a mass transmission window of the mass filter, scanning the mass transmission window of the mass filter over a mass range of interest, and adjusting a width of the mass transmission window of the mass filter over at least a portion of said mass range of interest during said scanning of the mass transmission window. In some embodiments, the step of adjusting the width of the mass transmission window can be performed based on the density of m/z peaks associated with the ions passing through the mass filter.

Further understanding of various aspects of the present teachings can be obtained by reference to the following detailed description in conjunction with the associated drawings, which are described briefly below.

### BRIEF DESCRIPTION OF THE DRAWINGS

FIG. 1 is a flow chart depicting various steps in a method according to an embodiment of the present teachings for acquiring mass data in a mass spectrometric system according to the present teachings,

FIG. 2A schematically depicts an example of a mass selection window that allows transmission of ions having m/z ratios between M1 and M2,

FIG. 2B schematically depicts the scanning of the mass selection window depicted in FIG. 2A,

FIG. 3A shows a total ion current (TIC) data acquired for a NIST standard sample (Nist195) prepared using a Folch extraction method,

FIG. 3B is a mass survey spectrum associated with one of the peak in the TIC data,

FIG. 3C is a low-resolution mass spectrum associated with an m/z region in the mass survey spectrum depicted in FIG. 3B,

FIG. 3D shows a transformation of the data depicted in FIG. 3C in which the number of observed mass peaks per 5-D window width as a function of precursor m/z is depicted,

FIG. 4A shows an example of a width function that can be utilized to adjust the width of the mass selection window over the mass range associated with the survey scan depicted in FIG. 3B,

FIG. 4B shows an example of a function indicative of variation of the scan rate of the mass selection window over the mass range associated with the survey scan depicted in FIG. 3B,

FIG. 5A schematically depicts a mass spectrometer that is configured to operate in data acquisition mode in accordance with an embodiment of the present teachings,

FIG. 5B schematically depicts an end view of a plurality of rods arranged in a quadrupole configuration that are utilized in a mass filter incorporated in the mass spectrometer of FIG. 5A, and

FIG. 6 schematically depicts an example of an implementation of a controller utilized in a mass spectrometer according to various embodiments of the present teachings.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the applicant's teachings may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and “substantially equal” refer to variations in a numerical quantity that can occur, for example, through measuring or handling procedures in the real world; through inadvertent error in these procedures; through differences in the manufacture, source, or purity of compositions or reagents; and the like. Typically, the terms “about” and “substantially” as used herein mean 10% greater or less than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

As used herein the term “and/or” includes any and all combinations of one or more of the associated listed items and may be abbreviated as “/”.

Various terms are used herein according to their ordinary meanings in the art. The term “dwell time” is used herein to refer to the time spent for counting ions for a particular parent mass transmission at the detector of a mass spectrometer.

The term “high-mass-cut-off” as used herein refers to a maximum m/z ratio associated with an ion filter such that all ions having m/z ratios less than that maximum m/z ratio can pass through the filter and ions having m/z ratios greater than the maximum m/z ratio are inhibited from passing through the filter.

The term “low-mass-cut-off” as used herein refers to a minimum m/z ratio associated with an ion filter such that all ions having m/z ratios greater than that minimum m/z ratio can pass through the filter and ions having m/z ratios less than the minimum m/z ratio are inhibited from passing through the filter.

The term “bandpass filter” refers to an ion filter that allows the passage of ions having m/z ratios within an m/z range through the filter while inhibiting ions having m/z ratios outside that m/z range from passing through the filter. The m/z range is herein also referred to the bandpass window.

The terms “survey scan” and “mass survey scan” are used herein interchangeably to refer to a collection of full mass data over a mass range of interest without fragmentation or isolation of a specific parent ion.

The term “width of a mass selection window” refers to a mass range of ions that can pass through a mass filter.

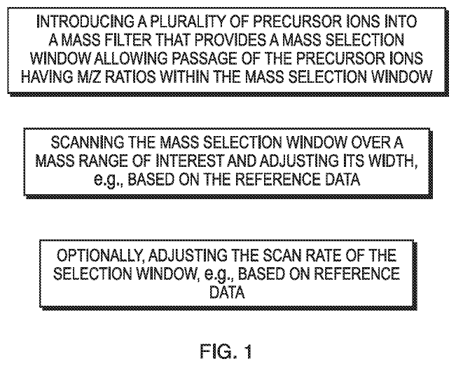

With reference to the flow chart of FIG. 1, in a method according to an embodiment for acquiring mass data in a mass spectrometric system, a plurality of ions is introduced into a mass filter that provides a mass selection window allowing passage of those precursor ions that have m/z ratios within the mass selection window.

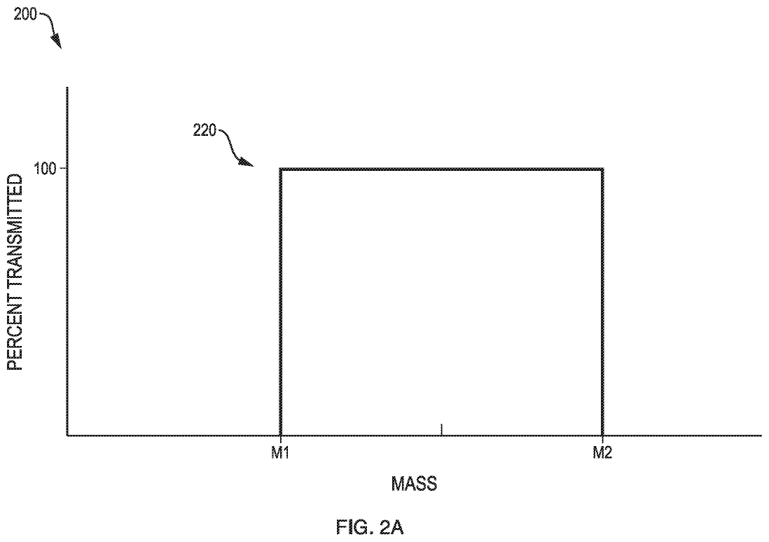

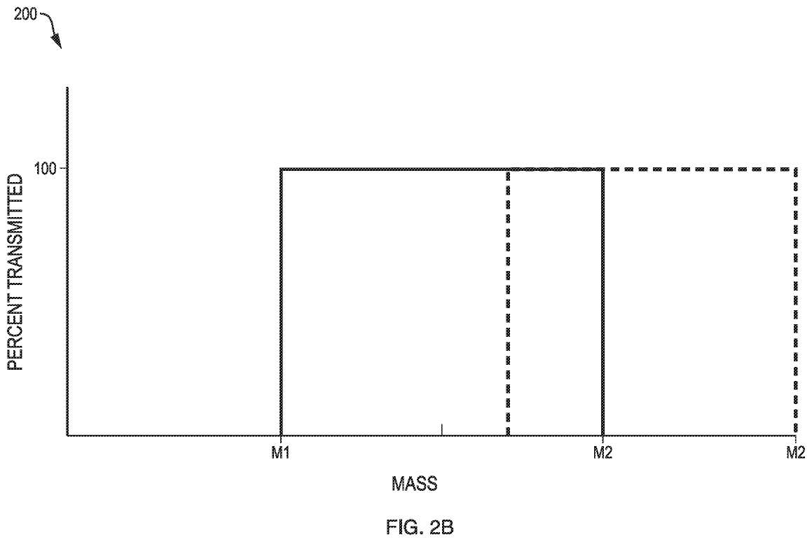

By way of example, FIG. 2A schematically depicts an example of a mass selection window 200 that allows transmission of ions having m/z ratios between M1 and M2. Although the schematic depiction of the mass selection window shows sharply defined edges at masses M1 and M2, in many mass filters, the edges are not so sharply defined.

In some embodiments, a mass selection window suitable for use in the practice of the present teachings, such as the mass selection window that is schematically depicted in FIG. 2A, can be generated using a mass filter having a plurality of rods arranged in a multipole configuration. More specifically, the application of RF and DC voltages to the rods in a manner known in art can result in a mass selection window extending from a lower m/z ratio MI to an upper m/z ratio M2, as shown schematically in FIG. 2A. In this example, the width of the mass selection window in m/z space is defined as M2-M1.

With continued reference to the flow chart of FIG. 1, the mass selection window can be scanned and its width can be adjusted during mass data acquisition. For example, the RF voltage applied to the multipole rods of a mass filter can be varied (e.g., ramped) so as to scan the mass selection window in the parent m/z dimension. In various embodiments, the RF voltage applied to the multipole rods can be varied continuously, as opposed to step-wise variation, to provide a continuous scanning of the mass selection window across a mass range of interest.

By way of example, FIG. 2B schematically depicts scanning of the mass selection window shown in FIG. 2A. Although FIG. 2B shows two versions of the mass selection window separated in time, it should be understood that in various embodiments, the mass selection window is moved (scanned) continuously, rather than in steps, across the mass range of interest.

In addition to scanning the mass selection window, the width of the mass selection window can also be adjusted based on mass reference data. For example, prior to each measurement cycle, e.g., prior to each MRM cycle, a mass survey scan be performed to identify the mass-to-charge ratios of precursor ions present in a mass range of interest. The data acquired via such a survey scan, which is herein also referred to as mass reference data or simply as reference data, can then inform the adjustment of the width of the mass selection window during the respective measurement cycle.

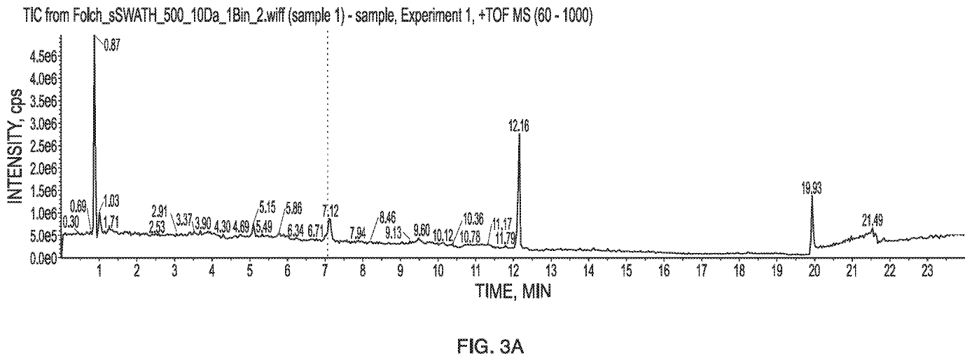

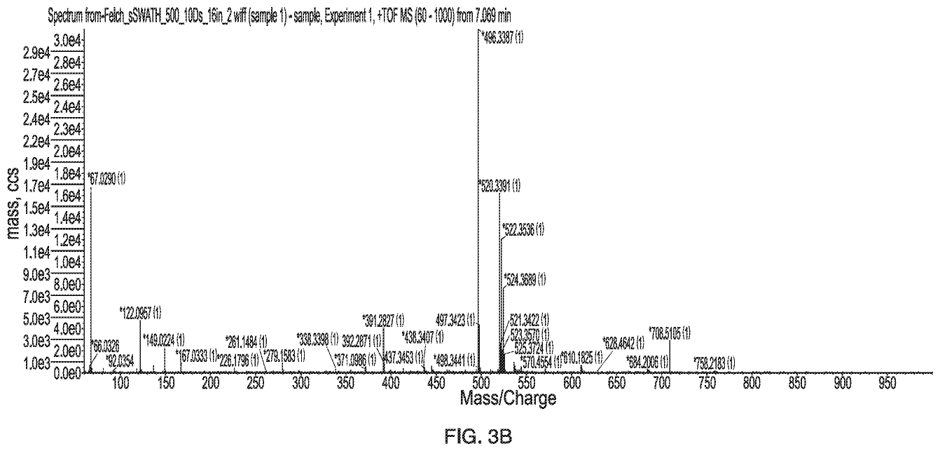

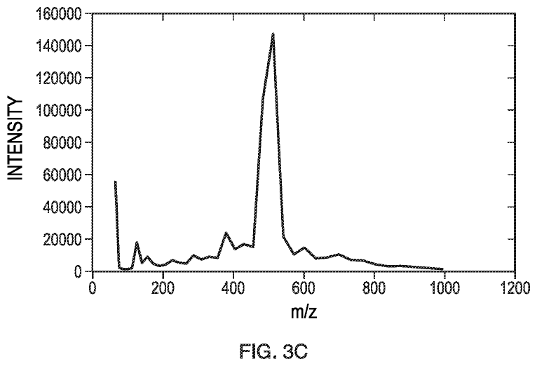

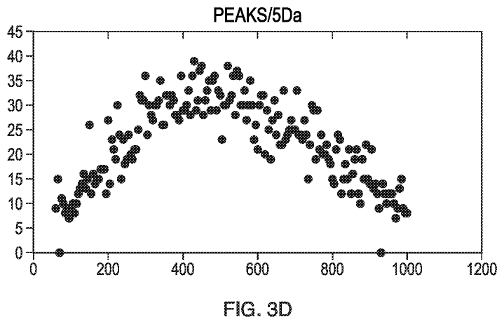

By way of illustration, FIG. 3A shows a total ion chromatogram (TIC) acquired on a Zeno-TOF Sciex 7600 mass spectrometer for a NIST standard sample ((Nist195) that was prepared using a Folch extraction method, where the mass spectrometer was modified in accordance with embodiments of the present teachings for the acquisition of data described herein. FIG. 3B shows a mass survey scan associated with the peak in the TIC data identified by the vertical dashed line.

In some embodiments, the mass survey data may be transformed such that each point represents the sum of a default or starting mass selection window. By way of illustration, FIG. 3C depicts an example of such transformation of the mass survey data depicted in FIG. 3B.

In some other embodiments, the mass survey data can be transformed by calculating the number of observed mass peaks per window width as a function of precursor m/z. By way of example, FIG. 3D shows such a transformation of the mass survey data depicted in FIG. 3C, where the transformed mass survey data shows the number of mass peaks per 5-Da window width.

As the width of the mass selection window increases, so does the mass measurement sensitivity. However, such an increase in measurement sensitivity is at the expense of a lower specificity, i.e., a greater convolution/complexity of the product ions spectra. In other words, the number of parent ions with different m/z ratios that are co-isolated in a mass filter (e.g., the Q1 mass filter discussed below) can increase. Further, those parent ions that are co-isolated may produce fragment ions that cannot be sufficiently resolved within the resolution limit of the instrument or within the data processing window used for data extraction.

In various embodiments, in order to ameliorate the potential reduction in specificity while collecting data over a mass range having a high density of mass peaks, the width function for adjusting the width of the mass selection window can be configured to be proportional to the inverse of the intensity sum transformation. Further, in various embodiments, since the number of mass peaks per default or test window width is directly indicative of a greater precursor ion multiplexity and hence a greater complexity of the product ions spectrum, the width function can be also inversely proportional to the peaks/Da function.

For example, the width of the mass selection window can be decreased as the mass selection window is scanned over a mass region for which the mass reference data indicates a higher density of mass peaks. In contrast, the width of the mass selection window can be increased as the mass selection window is scanned over a mass region for which the mass reference data indicates a lower density of mass peaks.

In various embodiments in which the mass selection window is generated via a mass filter having a multipole set of rods to which RF and DC voltages are applied, the adjustment of the width of the mass selection window can be achieved via adjusting the RF and DC voltage(s) applied to the rods, in a manner known in the art as informed by the present teachings.

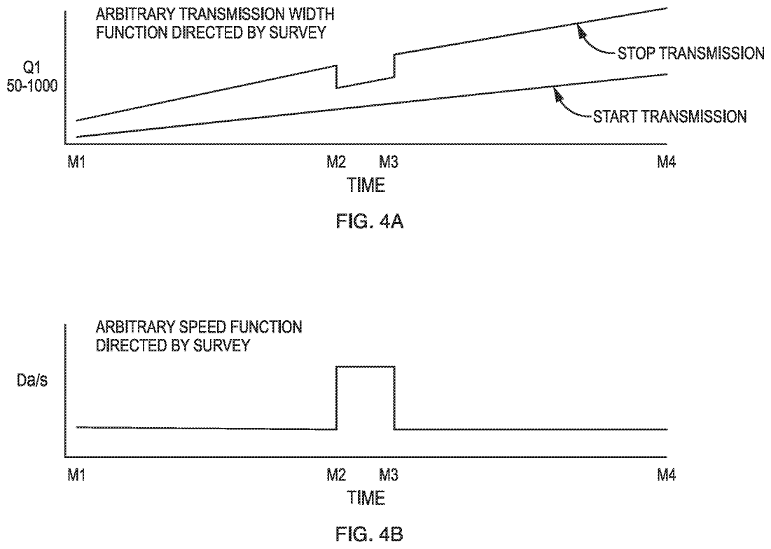

By way of illustration, FIG. 4A shows an example of a width function that can be utilized to adjust the width of the mass selection window over the mass range associated with the survey scan depicted in FIG. 3B. The width functions that can be employed in the practice of the present teachings are not limited to that shown in FIG. 4A. In fact, it is also possible to define width functions based on the measurement of the number of spectral widths per mass unit.

As depicted in FIG. 4A, in this example, in a mass region between M1 and M2, the width of the mass selection window shows a continuous, gradual increase. However, the width of the mass selection window shows a significant step-wise decrease for a mass region extending between M2 and M3. As seen in the survey scan depicted in FIG. 3B, the density of the mass peaks increases substantially in the mass region between M2 and M3. The decrease in the width of the mass selection window in this mass region allows obtaining an enhanced selectivity in the collected mass data. In other words, the decrease in the width of the mass selection window limits the number of precursor ions that pass through the mass filter at a given time and hence facilitates the deconvolution of the mass peaks associated with the product ions.

With continued reference to FIG. 4A, subsequent to scanning the mass selection window over the mass region extending between M2 and M3, the width of the mass selection window shows a step-wise increase and the width continues to increase gradually in a mass region extending between M3 and M4.

The width function depicted in FIG. 4A is for illustration purposes and is not limiting of the types of width functions that may be employed in the practice of the present teachings. For example, in some embodiments, the width of the mass selection window may remain substantially uniform except for the region between M2 and M3, where the width of the mass selection window is decreased in step-wise fashion. In other cases, multiple reductions in the width of the mass selection window may be needed between M1 and M4. In general, in various embodiments, the width function can be implemented based on the distribution of mass peaks expected within a mass range of interest.

Referring again to the flow chart of FIG. 1, in some embodiments, in addition to scanning the mass selection window and adjusting the width of the mass selection window based on reference mass data, the rate at which the mass selection window is scanned can also be optionally adjusted based on the mass reference data. For example, in mass regions in which the mass reference data shows mass peaks with low intensities, e.g., intensities below a predefined threshold, the scan rate of the mass selection window can be reduced to increase the dwell time for obtaining mass data associated with the precursor ions and hence improve the signal-to-noise ratio of the collected mass data.

Conversely, in mass regions in which the observed mass peaks exhibit a high intensity, e.g., above a predefined threshold, the scan rate of the mass selection window can be increased to expedite the data acquisition. Further, in some embodiments, the scan rate of the mass selection window can be increased when scanning over mass regions for which the mass reference data does not show any mass peaks, or shows mass peaks that are sparsely distributed.

By way of illustration, FIG. 4B shows an example of a function indicative of variation of the scan rate of the mass selection window over the mass range associated with the mass survey scan depicted in FIG. 3B. As the scan survey data shows a significant increase in the intensities of the observed mass peaks in the mass region between M2 and M3, the scan rate function exhibits a step-wise increase in the scan rate over this mass range. At mass M3, the scan rate shows a step-wise decrease with the scan rate remaining constant between M3 and M4.

Again, the function depicted in FIG. 4B is only for illustration purposes. Other types of functions may also be employed, e.g., based on the mass data and a desired application.

In embodiments in which the scanning of the mass selection window is achieved via varying the RF voltage applied to multipole rods of a mass filter, the scan rate can be adjusted via changing the rate at which the RF voltage is varied.

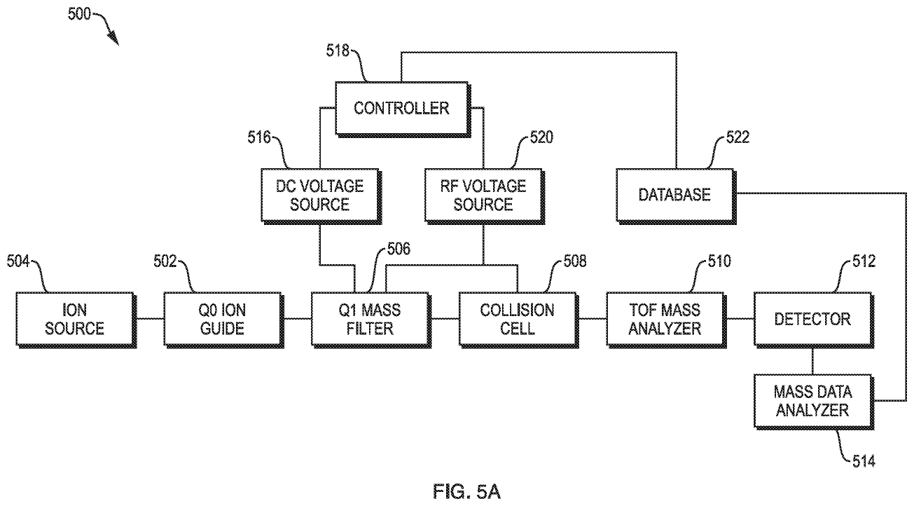

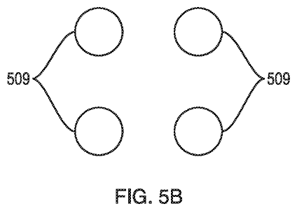

By way of example, FIG. 5A schematically depicts a mass spectrometer 500 which is configured to operate in data acquisition mode in accordance with the present teachings. More specifically, the mass spectrometer 500 includes an ion source 504 that receives a sample, e.g., from an LC column, and ionizes at least a portion thereof to generate a plurality of precursor ions that are received by the ion guide 502, which focuses the ions to generate an ion beam, which is received in turn by a downstream ion mass filter 506. In this embodiment, the mass filter includes a set of rods 509 (shown schematically in FIG. 5B) that are arranged according to a quadrupole configuration.

An RF voltage source 520 and a DC voltage source 516 operating under control of a controller 518 can apply RF and DC voltages to the rods to generate a mass selection window.

More specifically, the applied RF voltages can generate a radial electromagnetic field that provides a low-mass-cut-ff (LMCO) and the DC voltages applied to the rods provide a high-mass-cut-off (HMCO) for passage of the ions through the mass filter such that the combination of the LMCO and the HMCO provides a mass selection window extending between the LMCO and the HMCO. In other words, the mass filter allows the passage of ions with m/z ratios within the transmission window while inhibiting the passage of ions with m/z ratios outside the transmission window.

The ions passing through the mass filter 506 are received by a fragmentation device 508, which is a collision cell in this embodiment, and undergo fragmentation to generate a plurality of product ions. In this embodiment, a time-of-flight (ToF) mass analyzer 510 receives the product ions and separates the product ions based on their mass-to-charge (m/z) ratios. An ion detector 512 of the ToF mass analyzer generates ion detection signals in response to incidence of ions thereon and a mass data analyzer 514 receives the ion detection signals and processes the ion detection signals to generate a mass spectrum of the product ions.

Further, the mass data analyzer 514 can be configured to correlate the detected product ions to specific precursor ions. By way of example, the mass data analyzer 514 can be configured to implement data analysis methods disclosed in published International Application Number PCT/IB2014/002038 entitled “Systems And Methods For Identifying Precursor Ions From Product Ions Using Arbitrary Transmission Windowing,” which is herein incorporated by reference in its entirety, as informed by the present teachings can be utilized for analysis of the mass data, and more particularly for identifying, for each product ion observed in the mass spectrum of the product ions, a precursor ion associated therewith.

More specifically, in some embodiments, for each product ion a function can be constructed that describes how an intensity of the mass peak corresponding to that product ion varies with precursor ion mass as the mass selection window is scanned over the mass range of interest. Such a function can then be utilized to identify the precursor ion associated with the product ion. By way of example, and without limitation, in some embodiments, a precursor ion having a mass corresponding to a maximum of the function can be identified as the precursor ion corresponding to the product ion.

The controller 518 can be configured to perform data acquisition in accordance with the present teachings. For example, the controller 518 can be programmed with instructions for implementing particular functions for adjusting the width and/or optionally the scan rate of the mass selection window. Further, the controller 518 can be programmed to analyze the product mass data, e.g., in a manner indicated above.

For example, the controller can be programmed to conduct a mass survey scan prior to each measurement cycle to identify precursor mass peaks within a mass range of interest. More specifically, the mass data analyzer 514 can receive the ion detection signals generated by the ion detector during a mass survey scan and can process the ion detection signals to generate a mass spectrum associated with the precursor ions (herein referred to also as mass reference data or simply reference data). In this embodiment, the mass reference data generated via the mass survey scan can be stored in a database 522. The controller 518 can communicate with the database 522 to access the mass reference data and can utilize the mass reference data to adjust the width of the mass selection window and/or optionally the rate at which the mass selection window is scanned based on the mass reference data in a manner disclosed herein.

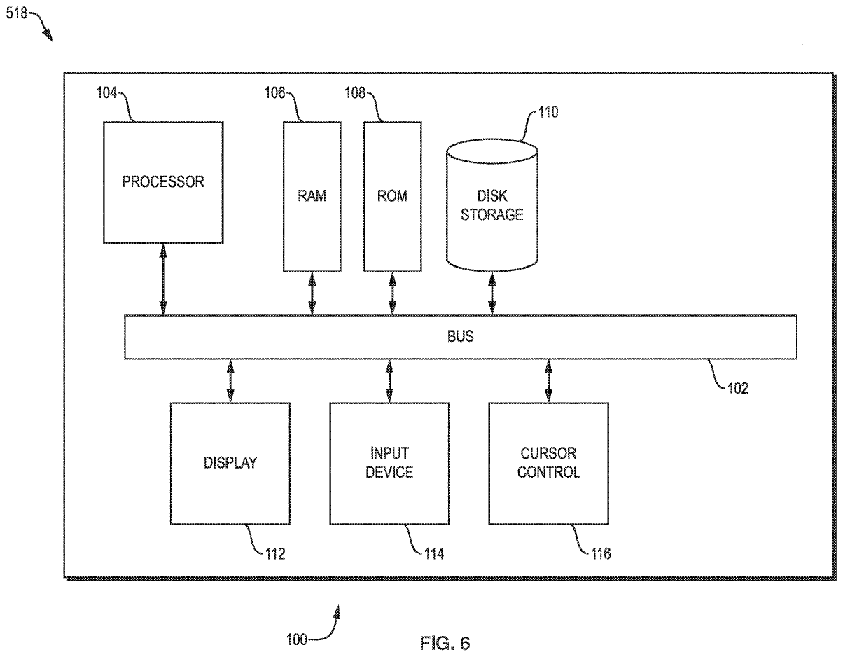

The controller 518 can be implemented in hardware, software and/or firmware in a manner known in the art as informed by the present teachings. By way of illustration, FIG. 6 schematically depicts an example of an implementation of the controller 518, which includes a bus 102 or other communication mechanism for communicating information, and a processor 104 coupled with bus 102 for processing information. The controller 518 also includes a memory 106, which can be a random-access memory (RAM) or other dynamic storage device, coupled to bus 102 for storing instructions to be executed by processor 104. By way of example, the instructions can relate to the manner in which the width of the mass selection window and optionally the rate at which the mass selection window need to be scanned over the mass range of interest.

Memory 106 also may be used for storing temporary variables or other intermediate information during execution of instructions to be executed by processor 104. The controller 518 further includes a read-only memory (ROM) 108 or other static storage device coupled to bus 102 for storing static information and instructions for processor 104. A storage device 110, such as a magnetic disk or optical disk, is provided and coupled to bus 102 for storing information and instructions.

The controller 518 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112. This input device typically has two degrees of freedom in two axes, a first axis (i.e., x) and a second axis (i.e., y), that allows the device to specify positions in a plane.

The term “computer-readable medium” as used herein refers to any media that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as memory 106. Transmission media includes coaxial cables, copper wire, and fiber optics, including the wires that comprise bus 102.

Common forms of computer-readable media include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings.

Additionally, the described implementation includes software but the present teachings may be implemented as a combination of hardware and software or in hardware alone. The present teachings may be implemented with both object-oriented and non-object-oriented programming systems.

1. A method of acquiring mass data in a mass spectrometric system, comprising:
introducing a plurality of ions into a mass filter providing a mass selection window to allow passage of precursor ions having m/z ratios within the mass selection window through the mass filter, and
scanning the mass selection window and adjusting a width of the mass selection window across a mass range during acquisition of mass data.

2. The method of claim 1, wherein said step of scanning the mass selection window is achieved via variation of at least a first operating parameter of the mass filter.

3. The method of claim 1, wherein said step of adjusting the width of the mass selection window comprises varying at least a second operating parameter of the mass filter.

4. The method of claim 1, wherein said mass filter comprises a plurality of rods arranged in a multipole configuration.

5. The method of claim 4, wherein said at least a first operating parameter comprises an RF voltage applied to at least one of said rods.

6. The method of claim 3, wherein said mass filter comprises a plurality of rods arranged in a multipole configuration, and wherein said at least a second operating parameter comprises a DC resolving voltage applied to at least one of said rods.

7. The method of claim 1, further comprising causing fragmentation of the precursor ions passing through said mass selection window to generate a plurality of ion fragments.

8. The method of claim 7, further comprising acquiring mass data associated with said ion fragments.

9. The method of claim 8, further comprising analyzing said mass data to generate a mass spectrum of said ion fragments.

10. The method of claim 1, wherein said step of adjusting the width of the mass selection window is based on mass reference data indicative of expected mass peaks within an m/z range for which mass data is to be acquired.

11. The method of claim 10, further comprising performing a survey scan to generate said mass reference data.

12. The method of claim 11, wherein the step of adjusting the width of the mass selection window comprises reducing the width of the window for an m/z range characterized by a dense distribution of mass peaks in said mass reference data.

13. The method of claim 11, wherein the step of adjusting the width of the mass selection window comprises increasing the width of the window for an m/z range characterized by a sparse distribution of mass peaks in said mass reference data.

14. The method of claim 11, further comprising adjusting a rate of scanning of said mass selection window based on said mass reference data.

15. The method of claim 14, wherein said step of adjusting the rate of scanning comprises reducing the rate of scanning for an m/z range characterized by at least one mass peak for which an increased dwell time is desired.

16. The method of claim 14, wherein said step of adjusting the rate of scanning comprises increasing the rate of scanning for acquisition of mass data in an m/z range characterized by one or mass peaks having an expected intensity less than a threshold.

17. A mass analysis system, comprising:
a mass filter for receiving a plurality of precursor ions, and
a controller for causing scanning of a mass selection window provided by the mass filter and adjusting a width of said mass selection window during acquisition of mass data.

18. The mass analysis system of claim 17, further comprising a fragmentation device positioned downstream of the mass filter for receiving and fragmenting at least a portion of the precursor ions to generate a plurality of fragment ions.

19. The mass analysis system of claim 17, wherein said controller is configured to utilize mass reference data for adjusting the width of said mass selection window, and wherein optionally the controller is further configured to adjust a rate of scanning of the mass selection window based on said mass reference data.

20. The mass analysis system of claim 19, wherein said mass reference data corresponds to data obtained via a survey scan.
